(19) United States
(12) Patent Application Publication
(10) Pub. No.: US 2022/0334653 A1
(43) Pub. Date: Oct. 20, 2022

(54) Controller Device And Method Of Use

(71) Applicant: Gabriel Garsombke, New Berlin, WI (US)

(72) Inventor: Gabriel Garsombke, New Berlin, WI (US)

(21) Appl. No.: 17/720,021

(22) Filed: Apr. 13, 2022

Related U.S. Application Data
(60) Provisional application No. 63/174,871, filed on Apr. 14, 2021.

(51) Int. Cl. G06F 3/038; G06F 3/0338; G06F 3/02

(52) U.S. Cl. CPC G06F 3/038; G06F 3/0338; G06F 3/0216

(57) ABSTRACT

The invention provides for a controller device and corresponding method to be used with a personal computer. The invention can be used with a computer mouse and/or a keyboard to better provide user inputs. The invention primarily comprises an ergonomic body allowing for a user to comfortably rest their hand and align their fingers with a plurality of input devices. The input devices may be 2-axis joysticks with an integrated switch, keyboard switches, directional pads, or other means of converting a mechanical motion into an electrical signal. The controller device may connect to a personal computer using a USB cable or utilizing wireless technologies. User customization can occur using mechanical connections such as detachable palm rests, thumb caps, and even sections of the body. There are also software customizations such as auto-calibrating the joystick's baseline electrical signal noise and sensitivity and LED colors of various LEDs located within the device.

### CROSS-REFERENCE(S) TO RELATED APPLICATION(S)

This present application claims priority on U.S. Provisional Patent Application Ser. No. 63/174,871, filed on Apr. 14, 2021 and entitled Controller Device and Method of Use, the entire contents of which are hereby expressly incorporated by reference into the present application.

### BACKGROUND OF THE INVENTION

### 1. Field of the Invention

The present invention relates to a human interface device and method of use. More specifically, the invention relates to a controller device used to provide user inputs to software running on a personal computer.

### 2. Discussion of the Related Art

A variety of specialized controller devices have several advantages compared to traditional keyboards. These advantages include greater customizability, superior granularity of control and more ergonomic operation. Traditional keyboards are limited in the physical arrangement of their keys in order to comply with QWERTY or other keyboard layout standards. This often means that users are required to keep their hands in awkward and uncomfortable positions in order to efficiently provide user inputs to their personal computer. Traditional keyboards at times also lack sufficient granular control because the keys are unable to produce an analog signal or express more than two logic states. That is to say, the keys can only be either “off” or “on.”

What is therefore needed are controller devices that provide for greater customization of both the software and the hardware by a user. What is further needed are controller devices having greater granularity of input such as that provided by an analog joystick or a pressure sensitive keyboard switch. What is also needed are controller devices that are configured for comfortable, ergonomic operation.

### SUMMARY OF THE INVENTION

The presently claimed invention is a controller device and method to provide inputs to a personal computing device.

In one embodiment, the controller device includes a body having a top portion, a bottom portion, a right portion, and a left portion. An electrical circuit is positioned at least partially within the body and is configured to accept a collection of inputs and interface with a personal computing device. The personal computing device comprises a detachable USB cable protruding from the body, a rechargeable battery, and a wireless communication circuit configured to interface with a personal computing device using Bluetooth. The collection of inputs may include, a directional input, a first activation input, a second activation input, and third activation input located within the joystick.

The controller device further includes a 2-axis analog joystick positioned on the right portion of the body, in electrical communication with the electrical circuit. The 2-axis analog joystick is configured to produce a directional input, and also includes a tip which is attached to a thumbstick. The 2-axis analog joystick may also include a switch that may be used as a third activation input. The controller device further includes a pair of mechanical keyboard switches. Both of the pair of mechanical keyboard switches are positioned on the right portion of the body, and in electrical communication with the electrical circuit. The first mechanical keyboard switch is configured to produce a first activation input, whereas the second mechanical keyboard switch is configured to produce a second activation input.

The controller device further comprises at least one non-slip foot or pad positioned on the bottom portion of the body, and a palm rest positioned on the left portion of the body and configured to accept at least a portion of a human hand, itself comprising a soft upper layer for comfort. For instance, the soft upper layer may be a thermoplastic elastomer (TPE) material.

In some embodiments of the invention, at least one of the mechanical keyboard switches includes an LED and/or a pressure sensing circuit.

In some embodiments, the controller device further comprising a four-way directional pad positioned on the right portion of the body, in electrical communication with the electrical circuit, and configured to produce a second directional input, and the collection of inputs further comprises a second directional input.

In some embodiments, the wireless communication circuit is instead configured to use 802.11 family of wireless technology standards in addition to or instead of Bluetooth.

In some embodiments the controller device includes several physical customization features. This could include the mechanical keyboard switch configured to be hot-swappable. Additionally, the body may be configured to allow at least partial disassembly and replacement of the 2-axis analog joystick (and the joystick printed circuit board (PCB) itself which is attached by a ribbon cable to the main PCB assembly), and the palm rest further including a mechanical connection and configured to be detachable from the body. In some embodiments the mechanical connection between the joystick tip and thumbstick could include a magnet.

In some embodiments the controller device is further configured to allow for customization of inputs using the personal computing device. The customization of inputs includes binding standard keyboard keys to inputs in the collection of inputs, and/or calibrating the inputs in the collection of inputs, as well as customizing the lighting within the two keyboard switches.

A more general embodiment of the invention could be described as follows. A controller device for a personal computing device including a body having a first portion and a second portion; an electrical circuit positioned within the body and configured to accept a collection of inputs; a directional input device and an activation input device located in the second portion, in electrical communication with the electrical circuit and configured to produce the first input and a second input respectively; and a palm rest located in the first portion and configured to accept at least a portion of a human hand.

Another embodiment of the invention can be described as a method of providing inputs to a personal computing device comprising: powering on the personal computing device; connecting a controller device comprising, a body having a first portion and a second portion; an electrical circuit positioned within the body and configured to accept a collection of inputs; the collection of inputs comprising, at least a first input and a second input; a directional input device and an activation input device located in the second portion, in electrical communication with the electrical circuit and configured to produce the first input and a second input respectively; and a palm rest located in the first portion and configured to accept at least a portion of a human hand, to a personal computing device; placing a human hand onto the palm rest of the controller device; and providing inputs using at least a portion of the human hand.

In some embodiments, providing inputs using the human hand is accomplished by activating the directional input device and/or by activating the activation input device.

In some embodiments, the method further comprising configuring the controller device to produce a second collection of inputs and/or calibrating the controller device.

These, and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a top isometric perspective view of a controller device, according to an embodiment of the invention;

FIG. 2 is a top isometric perspective internal view of the controller device of FIG. 1;

FIG. 3 is a bottom isometric perspective internal view of the controller device of FIG. 1;

FIG. 4 is a block diagram of the electrical circuit and collection of inputs of the controller device of FIG. 1;

FIG. 5a is a block diagram of the pressure sensing circuit, shown in FIG. 4, which uses infrared technology;

FIG. 5b is a block diagram of the pressure sensing circuit, shown in FIG. 4, which uses a capacitive technology; and

FIG. 6 is a block diagram providing a method of use relating to the controller device of FIG. 1.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

### DETAILED DESCRIPTION OF PREFERRED EMBODIMENTS

The present invention and the various features and advantageous details thereof are explained more fully with reference to the non-limiting embodiments described in detail in the following description.

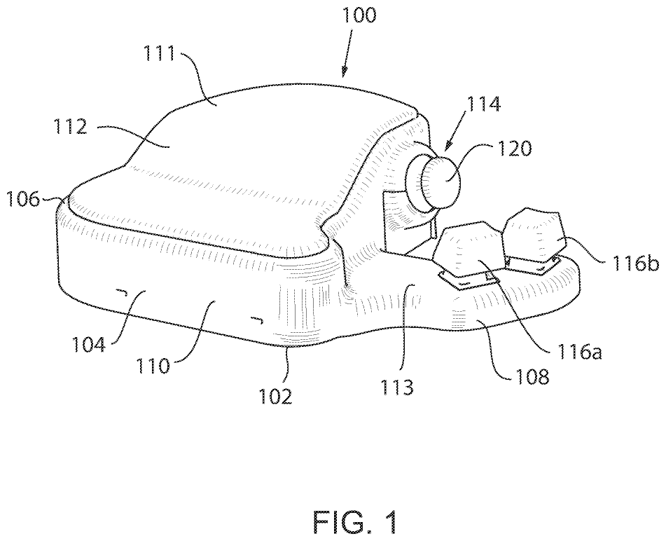

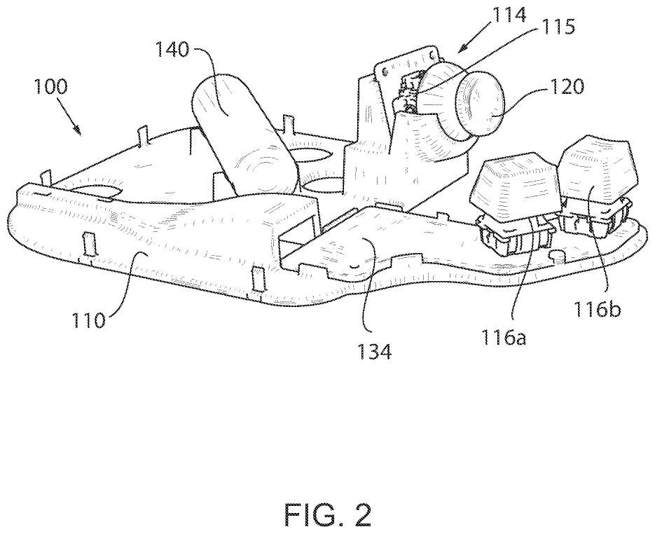

Referring to FIG. 1-3, a controller device 100 is shown having a body 110 with a bottom side 102, a back side 104, a left side 106, and a right side 108. The body 110 may also be described as having a first section 111 with a palm rest 112 and second section 113 with one or more user input devices, such as for instance a 2-axis joystick 114, mechanical keyboard switches 116a, 116b, joystick push button switch 115, and any other joysticks, remotes, etc. The body 110 may be constructed from a multitude of different materials including plastics and resins, using a variety of manufacturing processes including 3D printing, injection molding, or machining from a block of raw material. For instance, in one preferred embodiment, the body 110 is made of a durable, affordable plastic material such as acrylonitrile butadiene styrene (ABS), and the palm rest 112 is made of TPE. The body 110 is in a substantially ergonomic shape to comfortably allow for a user to operate the controller device 100 for extended periods of time.

As stated above, the body 110 includes a palm rest 112 to add to the comfortable operation of the device 100 and is shaped to accept at least a portion of a human hand. As described above, in one preferred embodiment, the palm rest 112 is made of TPE. Alternatively, the palm rest 112 may be made up of gel-infused memory foam. However, it could also be made from a single layer or from a different material that won't cause irritation if it comes into contact with human skin, such as woven fabrics made from cotton or polyester. The palm rest 112 could also include a mechanical connection (not shown) allowing for a user to detach the palm rest 112 and customize it to accommodate personal preferences. This could include different materials such as those discussed above or a multitude of different shapes and sizes. The mechanical connection could be clips, screws, or other mechanical fasteners to secure the palm rest 112 to the body 110. This mechanical connection could also use a pair of magnets to hold the palm rest 112 in place, or a single magnet and a section of magnetically responsive material, such as steel. Instead of using a mechanical connection, the palm rest 112 could instead be adhered in place for a more permanent solution using a strong adhesive, or by the injection molding practice of overmolding.

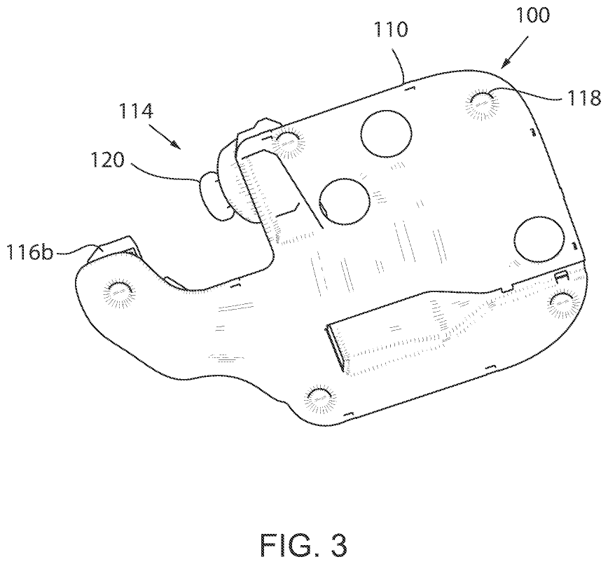

The body 110 also includes circular non-slip pads 118 along its bottom side where it would commonly contact a user's desk. In the current embodiment, there are a total of five of these non-slip pads 118 along the bottom of the body 110, but only one is called out in FIG. 3. In other embodiments, the non-slip pad 118 could be manufactured from a single sheet of material as to allow for maximum surface area. This is to hold the controller device 100 in place during operation and reduce the chances of erroneously providing inputs. The non-slip pads 118 additionally help protect a user's desk or work surface from being scratched or unintentionally damaged by operation of the controller device 100.

Still referring to FIGS. 1-3, the 2-axis joystick 114, or more generally, the directional input device 114, is positioned on the right side 108 of the body 110. The joystick 114 provides an electrical means to determine a directional vector along two axes. This is commonly achieved by measuring electrical resistance across a number of electrical contacts. A user varies this electrical signal by manipulating the stem of the joystick via the joystick's thumbstick 120, which has been suspended on a gimbal, to physically move one electrical contact point along each of the two separate potentiometers. This directional vector provides the basis for a user generated directional input 122. The body 110 has been designed in such a way as to be partially disassembled and the thumbstick 120 to be removed and replaced by the user. In other embodiments, the entire joystick assembly 114 could be removed and replaced. The joystick assembly 114 may be replaced via a ribbon cable and electrical connectors in the event of significant wear from use. This interchangeability allows the user to customize the height, geometry, surface finish, and material of the thumbstick 120 or entire joystick 114. In some embodiments of the present invention, there is a second directional input device such as a four-way directional pad (not shown) that can provide a second directional input to the collection of inputs.

In another embodiment, further customization of the joystick 114 is achieved using a mechanical connection (not shown) between the joystick tip and thumbstick 120. This mechanical connection could be a traditional friction fitting between the joystick tip and thumbstick or could be more sophisticated such as a series of grooves and ridges cut into the thumbstick allowing for magnetic interaction between the joystick tip and thumbstick. This would allow for quick disassembly and attachment of alternative thumb cap designs. The grooves and ridges would be cut lengthwise and be shallower on the ends opposite each other. This would give the thumb cap a self-aligning quality, meaning that the grooves, ridges, and magnet would guide the section of the thumb cap into place after a user brings the sections in close proximity.

Similarly, the controller device 100 also includes a mechanical keyboard switch 116, or more generally, an activation input device 116. A single switch 116 may be provided, or as shown a pair of switches 116a, 116b may be provided. Of course, the controller device could also include additional switches as desired. This mechanical keyboard switch 116a, 116b provides a means for a user to generate an electrical signal at discrete times. In order to generate this electrical signal, a user physically presses down on the switch 116a, 116b which brings into contact two electrical contacts and completes an electrical circuit.

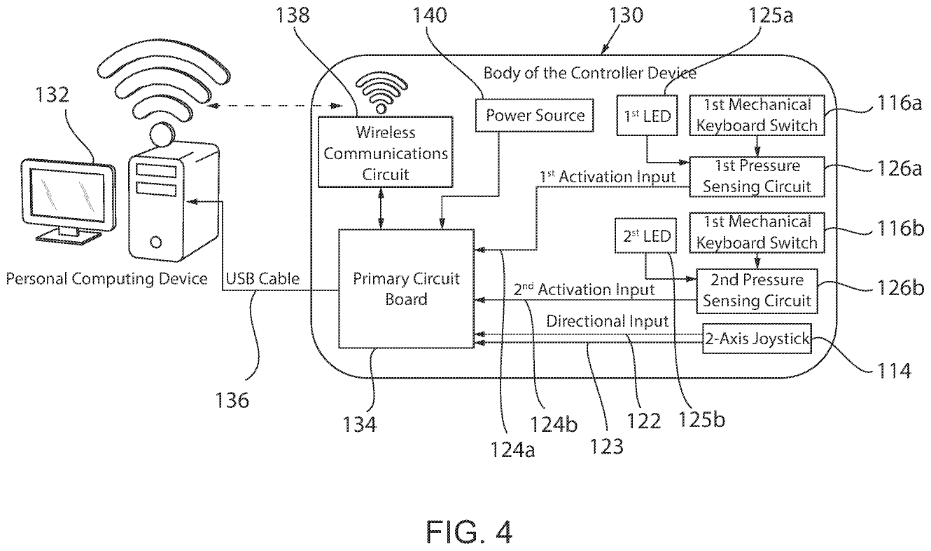

Additional features of the controller device 100 will now be described in connection with the block diagram of FIG. 4. This electrical signal provides the basis for a user generated activation input 124. This mechanical keyboard switch 116a, 116b may be configured to be “hot-swappable,” meaning that it can be electrically and physically disconnected from the controller device 100 and replaced with another different keyboard switch during its operation, without having to power down or stop operation of the controller device 100. As mentioned above, in the current embodiment, there are a pair of identical keyboard switches 116a, 116b disposed on the right side 108 of the body 110, each producing a discrete activation input 124. In other embodiments, the keyboard switches 116a, 116b could also include an LED 125a, 125b positioned within the switch 116a, 116b, respectively, and may be configured to provide the user information or more simply, a color choice of their choosing. For example, different colors could provide feedback that a user input is being properly received by the controller device 100 or to correspond to specific controller device configurations determined by software such as key bindings or sensitivity.

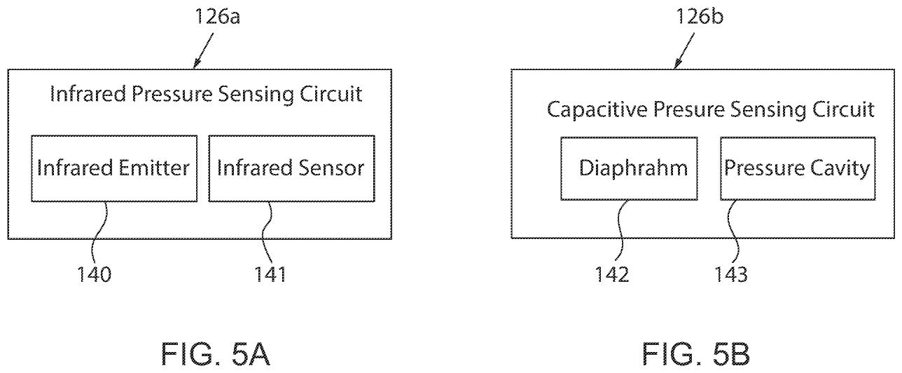

In some embodiments the mechanical keyboard switch 116a, 116b could be configured using a similar method as the joystick 114 to measure a vector in a single direction using a pressure sensing circuit 126, as shown in FIGS. 4, 5a, and 5b. Mechanical keyboard switches 116a, 116b commonly include a spring or other biasing member acting in the opposite direction as the activation direction. So, one method to measure pressure is to measure the distance a user has moved a key cap against this biasing member. The pressure a user applies to a keyboard switch 116a, 116b could also be measured in more direct ways using known methods including by measuring electrical resistances.

Still referring to FIG. 4 in conjunction with FIGS. 5a and 5b, in some embodiments, the pressure sensing circuit 126 uses infrared technology to measure the distance the keycap has been pressed by measuring the reflectance of the colored switch stem using an infrared technology. In that particular embodiment, the pressure sensing circuit 126 necessarily comprises an infrared emitter 140 and an infrared sensor 141 as shown in FIG. 5a. In other embodiments, the pressure sensing circuit 126 may further comprise a diaphragm 142 and a pressure cavity 143 to create a variable capacitor, and measures the pressure applied to the mechanical keyboard switch 116a, 116b by measuring changes in the circuit's 126 capacitance as shown in FIG. 5b.

Now referring to specifically FIG. 4, a block diagram is shown depicting the general configuration of the electrical circuit 130 and collection of inputs. The primary function of the controller device 100 is to accept a collection of inputs provided by a user and relay them to a personal computing device 132. In some embodiments, the personal computing device 132 is a personal computer, but could also be other electronic devices such as a tablet or smartphone. In the current embodiment, the collection of inputs includes a directional input 122 and three activation inputs 123, 124a, 124b. Commonly a user would use the controller device 100 to control a video game. The video game may use a directional input 122 to control the movement of a virtual avatar on screen or camera. The activation inputs 123, 124a, 124b may be used to signal affirmation or acceptance of the user to interact or trigger something in the video game such as selecting an option on a menu, signaling a virtual avatar to walk, run, jump, or perform some other physical activity, or shooting or use a weapon or use a tool or object.

In the current embodiment, a primary circuit board 134 is connected to all the various components necessary to operate the controller device 100. All these electrical connections and components are collectively referred to as the electrical circuit 130. The primary circuit board 134 is connected to the 2-axis joystick with internal switch 114 and the mechanical keyboard switches 116a, 116b allowing it to accept the corresponding directional input 122 and activation inputs 123, 124a, 124b respectively. In some embodiments a LED 125a, 125b is also connected to the primary circuit board 134 and may be positioned inside one of the mechanical keyboard switches 116a, 116b or anywhere else on the body 110 as long as it is visible to the user. The electrical circuit 130 may also include a detachable USB cable 136 protruding from the underside of the body 110 of the controller device 100, allowing the controller device 100 to interface with the personal computing device 132. Of course, the USB cable 136 could similarly be located anywhere else relative to the controller device 100. This USB cable 136 may also be configured to provide power to the controller device 100 if necessary and be connected integrally with the circuit or be made detachable. Although not included in the current embodiment, pressure sensing circuits 126a, 126b are provided in FIG. 4 for illustrative purposes. Here, they would be coupled to and work in tandem with their respective switches 116a, 116b, and electronically interface with the primary circuit board 134.

In yet other embodiments, the electrical circuit 130 includes a wireless communication circuit 138 instead of or in addition to the USB cable 136. The wireless communication circuit 138 could be configured to utilize any number of wireless technologies such as 802.11 b/g/n/ac/ax using 2.4 GHz or 5 GHz signals, Bluetooth, radio, infrared, or any other wireless communications standard or technology. If the embodiment only includes a wireless communication circuit 138 as a way to interface with a personal computing device 132, it will also include a power source 140 such as a disposable or rechargeable battery. For instance, the power source 140 may be a li-ion battery, where the charging and discharging of the battery is managed by the printed circuit board 134. A USB cable 136 not connected to the personal computing device 132, but instead connected to a wall mountable USB charger, may also be used to provide power to the controller device.

In another embodiment, the electrical circuit 130 is physically divided into several discrete sections, such as a section dedicated to the 2-axis joystick 114, one each for the mechanical keyboard switches 116a, 116b, one dedicated to the wireless circuit 138, etc., connected to each other using a number of ribbon cables or other detachable electrical connections. Similarly, the body 110 could be divided into any number of discrete sections to house the discrete sections of the electrical circuit 130 and the input devices, i.e., the 2-axis joystick 114, mechanical keyboard switches 116a, 116b, etc.

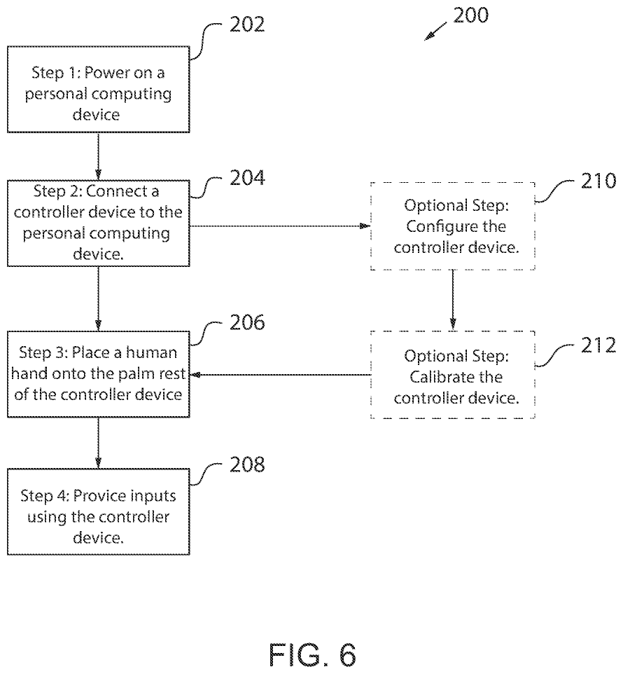

Referring to FIG. 6, a block diagram is shown describing the method 200 and individual steps a user would take to operate the controller device. The first step involves a powering step 202, where the personal computing device 132 is powered on. Next, is a connecting step 204, where the controller device described herein is connected to the personal computing device 132 either wirelessly 138 or via a cable 136. Third, a positioning step 206 is provided, where a user places his or her hand onto the palm rest 112 of the controller device. Lastly, an operation step 208, where a user provides inputs, such as a directional input 122 or an activation input 123, 124 using their hand and fingers to activate the directional input device, e.g., 2-axis joystick 114 and the activation input devices, e.g., mechanical keyboard switches 116a, 116b is provided. It should be noted that many of these steps may be performed in different order and still embody the claimed invention. For example, the connecting step 204 may be performed before the powering step 202 and still achieve a substantially similar result. Further, the method may include additional steps, and it could similarly include some but not all of the steps described herein.

According to another aspect of the invention, the operation method includes an optional configuration step 210 where the user configures the device 100 to produce a second collection of inputs. This step would allow for the user to customize the operation of the controller device 100 by assigning keys to specific inputs or by changing software variables such as sensitivity. The method could also include an optional further calibration step 212 where the controller device is calibrated to more accurately produce the collection of inputs. This would be in addition to the initial auto-calibration that occurs when the device software is initially started. This optional further calibration step 212 could be directed to any of the input devices 114, 116a, 116b, the wireless communication circuit 138, or any combination thereof. Both optional steps would be carried out with the aid of a software utility that runs on the personal computing device 132 and may occur at any point during the operation or setup of the controller device 100.

The above disclosure describes a number of different features and embodiments associated with the present invention. There are virtually innumerable uses for the present invention, all of which need not be detailed here. All the disclosed embodiments can be practiced without undue experimentation.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept. By way of example and not limitation, the disclosed controller device is configured in a “left hand” configuration, meaning that it is used by a left hand of a user. A similar device could be provided in a “right hand” configuration, in which the controller device is substantially mirrored off what is shown in the figures and described in this specification.

Additionally, in certain instances the above description describes various materials used with the described components. However, the individual components need not be fabricated from the disclosed materials, but could be fabricated from virtually any suitable materials.

Moreover, the individual components need not be formed in the disclosed shapes, or assembled in the disclosed configuration, but could be provided in virtually any shape, and assembled in virtually any configuration. Further, any of the components described herein could be separately made or manufactured as separate physical modules and later assembled. Also, some of all of the components could be made in combination with one another or may otherwise be integrated into the apparatus with which it is associated. Furthermore, all the disclosed features of each disclosed embodiment can be combined with, or substituted for, the disclosed features of every other disclosed embodiment.

It is intended that the appended claims cover all such additions, modifications and rearrangements. Expedient embodiments of the present invention are differentiated by the appended claims.

What is claimed is:

1. A controller device comprising:
a body having a top portion, bottom portion, right portion, and left portion;
a 2-axis analog joystick positioned on the body and configured to produce a directional input;
a first mechanical keyboard switch positioned on the body and configured to produce a first activation input;
a second mechanical keyboard switch positioned on the body and configured to produce a second activation input;
a third mechanical switch positioned with the joystick and configured to produce a third activation input;
a palm rest positioned on the body and configured to accept at least a portion of a human hand;
a collection of inputs comprising the directional input and the first activation input, the second activation input, and the third activation input; and
an electrical circuit positioned at least partially within the body in electrical communication with the 2-axis analog joystick, the first mechanical keyboard switch, the second mechanical keyboard switch, and the third mechanical switch, and configured to accept the collection of inputs and interface with a personal computing device.

2. The controller device of claim 1, further comprising a non-slip pad positioned on the bottom portion of the body.

3. The controller device of claim 1, wherein the palm rest further comprises a TPE upper layer.

4. The controller device of claim 1, wherein the electrical circuit further comprises a detachable USB cable protruding from the body configured to releasably connect to the personal computing device.

5. The controller device of claim 1, wherein the electrical circuit further comprises:
a battery, and
a wireless communication circuit configured to interface with a personal computing device.

6. The controller device of claim 1, at least one of the first mechanical keyboard switch and the second mechanical keyboard switch includes an LED.

7. The controller device of claim 1, at least one of the first mechanical keyboard switch and the second mechanical keyboard switch includes a pressure sensing circuit.

8. The controller device of claim 1, further comprising a four-way directional pad positioned on the right portion of the body, in electrical communication with the electrical circuit, and configured to produce a second directional input, and the collection of inputs further comprises a second directional input.

9. The controller device of claim 1, wherein the mechanical keyboard switch is configured to be hot-swappable.

10. The controller device of claim 1, wherein the body is configured to allow at least partial disassembly and replacement of the 2-axis analog joystick tip.

11. The controller device of claim 1, the palm rest further comprises a mechanical connection and is configured to be detachable from the body.

12. The controller device of claim 1, further configured to allow for customization of inputs using the personal computing device.

13. The controller device of claim 12, the customization of inputs includes binding standard keyboard keys to inputs in the collection of inputs.

14. The controller device of claim 12, the customization of inputs includes calibrating the inputs in the collection of inputs.

15. A controller device for a personal computing device comprising:
a body having a first portion and a second portion;
a collection of inputs comprising, a first input, a second input, and a third input;
an electrical circuit positioned within the body and configured to accept the collection of inputs;
a directional input device located in the second portion, in electrical communication with the electrical circuit and configured to produce the first input;
an activation input device located in the second portion, in electrical communication with the electrical circuit and configured to produce the second input; and
a palm rest located in the first portion and configured to accept at least a portion of a human hand.

16. A method of providing inputs to a personal computing device comprising the steps of:
powering on the personal computing device;
connecting a controller device to the personal computing device, the controller device comprising:
a body having a first portion and a second portion,
a palm rest located in the first portion and configured to accept a portion of a human hand,
a directional input device located in the second portion configured to produce the first input, and
an activation input device located in the second portion configured to produce the second input,
an electrical circuit positioned within the body in electrical communication with the directional input device and the activation input device, the electrical circuit configured to accept the first input and the second input;
placing a human hand onto the palm rest of the controller device; and
providing inputs using the human hand.

17. The method of claim 16, further comprising the step of providing inputs using the human hand by activating the directional input device.

18. The method of claim 16, providing inputs using the human hand by activating the activation input device.

19. The method of claim 16, further comprising the step of configuring the controller device to produce a second collection of inputs.

20. The method of claim 16, further comprising calibrating the controller device.
